(19) United States
(12) Patent Application Publication
(10) Pub. No.: US 2013/0016040 A1
(43) Pub. Date: Jan. 17, 2013

(54) METHOD AND APPARATUS FOR DISPLAYING SCREEN OF PORTABLE TERMINAL CONNECTED WITH EXTERNAL DEVICE

(71) Applicants: Man Hyuk AHN, Anyang-si (KR); Hyoung Il KIM, Seongnam-si (KR)

(72) Inventors: Man Hyuk AHN, Anyang-si (KR); Hyoung Il KIM, Seongnam-si (KR)

(73) Assignee: SAMSUNG ELECTRONICS CO. LTD., Suwon-si (KR)

(21) Appl. No.: 13/494,387

(22) Filed: Jun. 12, 2012

(30) Foreign Application Priority Data
Jul. 11, 2011 (KR) 10-2011-0068380

(51) Int. Cl. G06F 3/041; G06F 3/033

(52) U.S. Cl. 345/163; 345/173

(57) ABSTRACT

A method for displaying a screen of a portable terminal connected with an external device and including a touch screen is provided. The method includes activating an external output mode for outputting the screen of the portable terminal to the external device, transmitting the screen as a first screen, which is being outputted in the touch screen, by the portable terminal, in order to display the first screen on a display unit of the external device determining whether an output of a second screen, which is overlaid on the first screen or is displayed as a separate screen, is requested, and displaying the first screen in an entirety of the display unit of the external device when it is determined that the output of the second screen is requested, and displaying the second screen in the entirety of the touch screen of the portable terminal.

### PRIORITY

This application claims the benefit under 35 U.S.C. §119(a) of a Korean patent application filed on Jul. 11, 2011 in the Korean Intellectual Property Office and assigned Serial No. 10-2011-0068380, the entire disclosure of which is hereby incorporated by reference.

### BACKGROUND OF THE INVENTION

1. Field of the Invention

The present invention relates to a method and apparatus for displaying a screen of a portable terminal connected with an external device. More particularly, the present invention relates to a method and apparatus for displaying a screen of a portable terminal connected with an external device capable of displaying a first screen on the external device and displaying a second screen on the portable terminal so as to be an extension of the first screen currently being outputted or in a manner that an output of the second screen, which is divided and displayed, is displayed in a portable terminal connected with an external device.

2. Description of the Related Art

Recently, along with the development of information communication technologies and semiconductor technologies, use of portable terminals is rapidly increasing. Portable terminals are being utilized in efforts for a mobile convergence of traditional uses of portable terminals with other uses of other terminals. As an example, portable terminals, such as a mobile communication terminal, provide various functions, such as a TeleVision (TV) viewing function (e.g., a mobile broadcasting such as a Digital Multimedia Broadcasting (DMB) and a Digital Video Broadcasting (DVB)), a music replay function (e.g., a Motion Picture Expert Group (MPEG)-1 or MPEG-2 audio layer-3 (MP3)), a camera function, a data communication function, an Internet connection function, a short range wireless communication function, as well as a general communication function, and other similar functions that may be provided by a portable terminal. Likewise, as various functions are provided, recently, there is a need for the portable terminal to be more quickly and conveniently controlled by a user, and thus portable terminals are increasingly including a touch input device.

On a touch input device, if a touch occurs, physical attributes of a touched point are changed, and generation of a touch event may be determined to have occurred through such changes. For example, in the case of a touch input device of a capacitive touch input device, if a touch occurs at a touch point, a capacitance of the touched point is changed, and if such a change exceeds a preset threshold, it may be determined that a touch event has occurred at the touch point. Furthermore, full touch portable terminals including a touch screen are increasingly being used, wherein a button-type keypad, such as a numeric 3×4 keypad, or other similar keypads has been removed so that the functionality provided by the button-type keypad is provided by the touch screen of the full touch portable terminal. The full touch portable terminal may display a virtual keypad on the touch screen when letters, numbers, or other input information is being input. As such, the screen of the existing full touch portable terminal may be divided into a first screen for inputting letters when inputting letters and a second screen where a virtual keypad is displayed. Alternatively, the first screen and the second screen may be displayed in a manner such that the second screen is overlaid in an area of the first screen that occupies a part of the first screen. Likewise, as a virtual keypad may be output in a partial area of the screen, the size of each key is inevitably limited. As such, user's convenience may be lowered.

Furthermore, a portable terminal may provide an external output function that transmits the screen of the portable terminal to the external device (e.g., a TV-OUT function). However, the existing external output function transmits the screen of the portable terminal to the external device as it is. As such, the user of the portable terminal providing the external output function may have to input letters using a virtual keypad displayed in the part of the screen of the portable terminal even when the external device has been connected so as to display the screen of the portable terminal, thus, causing an inconvenience for the user of the portable terminal connected to the external device.

### SUMMARY OF THE INVENTION

Aspects of the present invention are to address at least the above-mentioned problems and/or disadvantages and to provide at least the advantages described below. Accordingly, an aspect of the present invention to is to provide a method and apparatus for displaying a screen of a portable terminal connected with an external device which separately outputs a first screen and a second screen in a portable terminal and an external device in a case where the output of the second screen is requested in the state where an external output function is activated and the first screen is outputted.

In accordance with an aspect of the present invention, a method for displaying a screen of a portable terminal connected with an external device and including a touch screen is provided. The method includes activating an external output mode for outputting the screen of the portable terminal to the external device, transmitting the screen as a first screen, which is being outputted in the touch screen, by the portable terminal, in order to display the first screen on a display unit of the external device, determining whether an output of a second screen, which is overlaid on the first screen or is displayed as a separate screen, is requested, and displaying the first screen in an entirety of the display unit of the external device when it is determined that the output of the second screen is requested, and displaying the second screen in the entirety of the touch screen of the portable terminal

In accordance with another aspect of the present invention, a method for displaying a screen of a portable terminal connected with an external device and including a touch screen is provided. The method includes activating an external output mode for outputting the screen of the portable terminal to the external device, determining a type of an application being executed by the portable terminal when the external output mode is being activated, and outputting on of a same screen or different screens in the touch screen of the portable terminal and the display unit of the external device according to the type of the application being executed.

In accordance with another aspect of the present invention, an apparatus for displaying a screen of a portable terminal connected with an external device is provided. The apparatus includes a touch screen for displaying a screen and for sensing a touch, and a controller for transmitting image data corresponding to a first screen being displayed on the touch screen to the external device upon activating an external output mode that outputs the first screen, for transmitting image data corresponding to the first screen to the external device when an output of a second screen that is overlaid on the first screen is requested to be displayed separately, and for transmitting image data corresponding to the second screen to the touch screen so as to be displayed on an entirety of the touch screen.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates connection between a portable terminal and an external device according to an exemplary embodiment of the present invention;

FIG. 2 is a block diagram schematically illustrating a portable terminal according to an exemplary embodiment of the present invention;

FIG. 3 is a flowchart illustrating a method of displaying a screen of a portable terminal connected with an external device according to an exemplary embodiment of the present invention;

FIG. 4 is an example of a screen for explaining a method of displaying a screen of a portable terminal connected with an external device according to an exemplary embodiment of the present invention;

FIGS. 5A and 5B are examples of a screen for displaying a virtual keypad of a portable terminal according to an exemplary embodiment of the present invention; and

FIG. 6 is a flowchart illustrating a method for displaying a screen of a portable terminal connected with an external device according to another exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

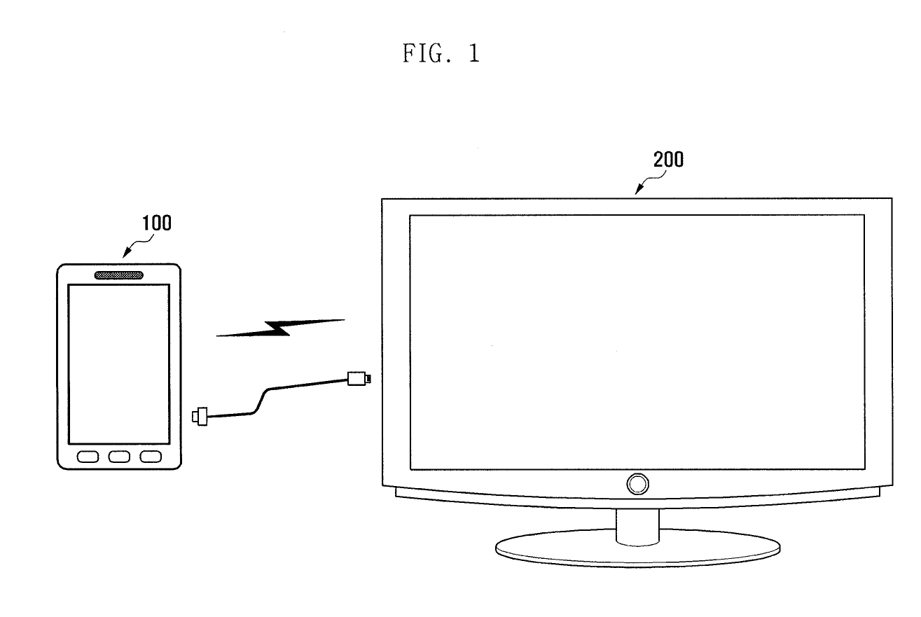

FIG. 1 illustrates connection between a portable terminal and an external device according to an exemplary embodiment of the present invention.

Referring to FIG. 1, a portable terminal 100 and an external device 200 may be connected through a wired cable or a short range wireless communication unit in order to provide an external output function (e.g., a TeleVision (TV)-OUT function) for the portable device 100. Specifically, the portable terminal 100 and the external device 200 may be connected by a High-Definition Multimedia Interface (HDMI) cable, a Universal Serial Bus (USB) cable, a micro USB cable, an Audio-Video (AV) cable, or another similar connection cable. Furthermore, the portable terminal 100 and the external device 200 may be connected through a Bluetooth communication unit, a Zigbee communication unit, an infrared communication unit, a Wi-Fi communication unit, a home Radio Frequency (RF) communication unit, a Digital Living Network Alliance (DLNA) communication unit, or another similar communication unit.

If the portable terminal 100 and the external device 200 are connected and an external output mode of the portable device 100 is activated, then the portable terminal 100 may transmit image data corresponding to a screen to be displayed by the external device 200 so that the portable terminal 100 and the external device 200 may output the same, related or corresponding screens. In particular, in a case where two screen outputs are requested, the portable terminal 100 may control the two screens so as to be separated and to be respectively outputted in the portable terminal 100 and the external device 200. The details thereof will be described later.

The portable terminal 100 may include a small-sized touch screen, and may be a Personal Digital Assistant (PDA), a mobile communication terminal, a smart phone, a tablet Personal Computer (PC), a Portable Multimedia Player (PMP), or other similar portable electronic devices, in order to provide an external output function. Further, the external device 200 may be a TV, a monitor, a Large Format Display (LFD), an electronic whiteboard, a touch monitor, or other similar electronic devices that may display an image.

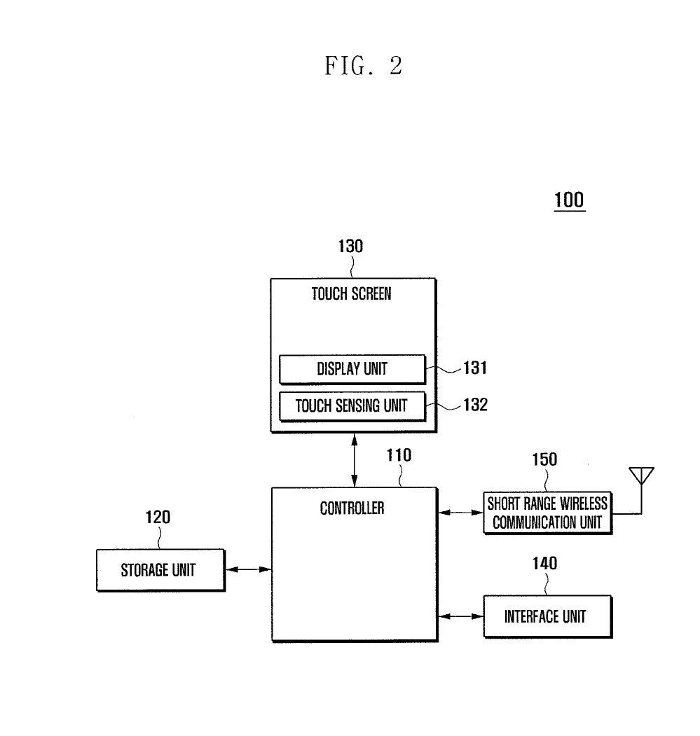

FIG. 2 is a block diagram schematically illustrating a portable terminal according to an exemplary embodiment of the present invention.

Referring to FIG. 2, a portable terminal 100 according to the present exemplary embodiment may include a short range wireless communication unit 150, an interface unit 140, a touch screen 130, a storage unit 120 and a controller 110. The touch screen 130 may include a display unit 131 and a touch sensing unit 132.

The short range wireless communication unit 150 may form a wireless communication channel with other portable terminals existing within a certain range under a control of the controller 110. In particular, the short range wireless communication unit 150 may form a wireless communication channel with other portable terminals while the portable terminal 100 is operating in an external output mode, and may also transmit image data to other portable terminals through the wireless communication channel. As discussed above, such a short range wireless communication unit 150 may use a short range wireless communication method such as a Bluetooth method, an infrared communication method, a Wi-Fi Peer-to-Peer (P2P) method, a Wi-Fi Direct method, a home RF method, a DLNA method, a Zigbee method, or other similar methods.

A wired cable may be inserted for a wired connection between the interface unit 140 and the external device 200. Image data may be transmitted to the external device 200 through the wired cable. The image data may include video data and audio data. The interface unit 140 may be formed by a USB cable, a micro USB cable, a HDMI cable, a 20 pole connector, or any other suitable connector or cable. Furthermore, in a case where the portable terminal 100 does not provide an external output function through a wired cable, then the interface unit 140 may be omitted according to certain embodiments of the present invention.

The touch screen 130 may perform an input function and an output function. The touch screen 130 may include a display unit 131 that performs an output function and a touch sensing unit 132 that performs an input function.

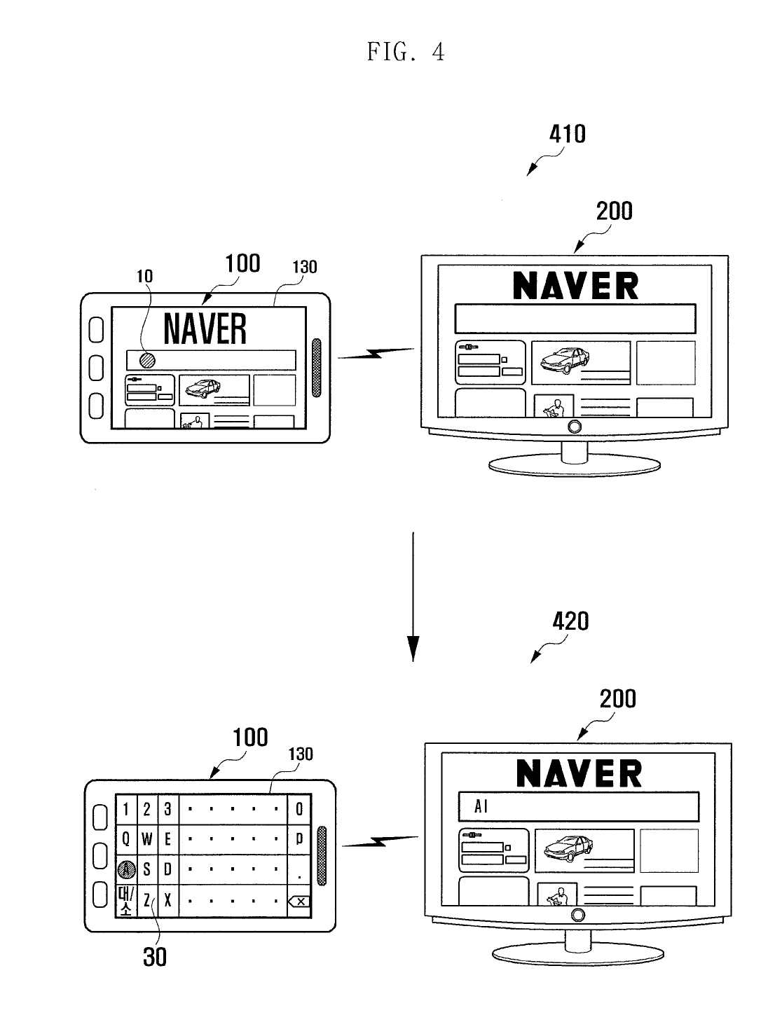

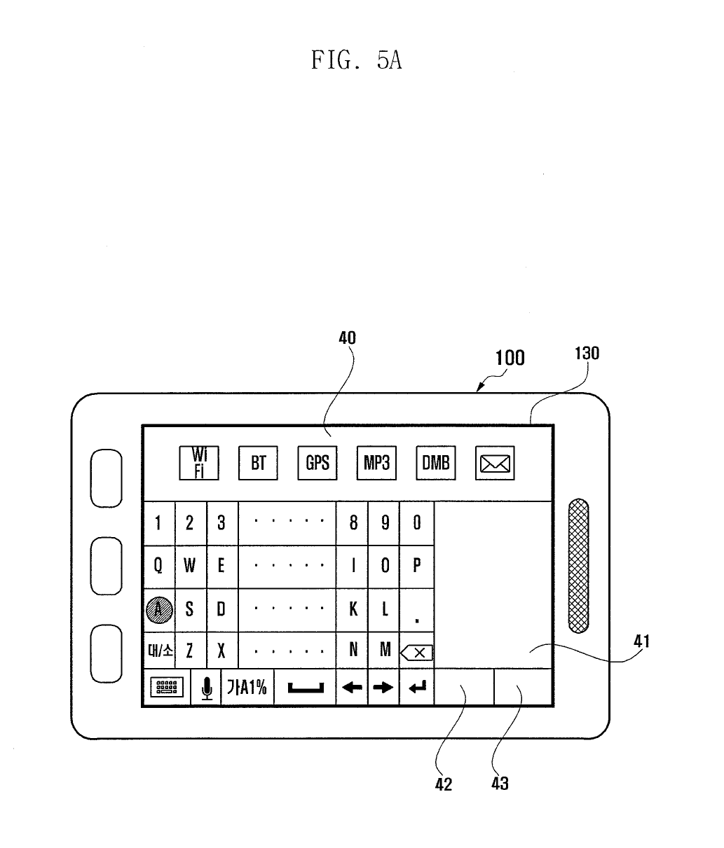

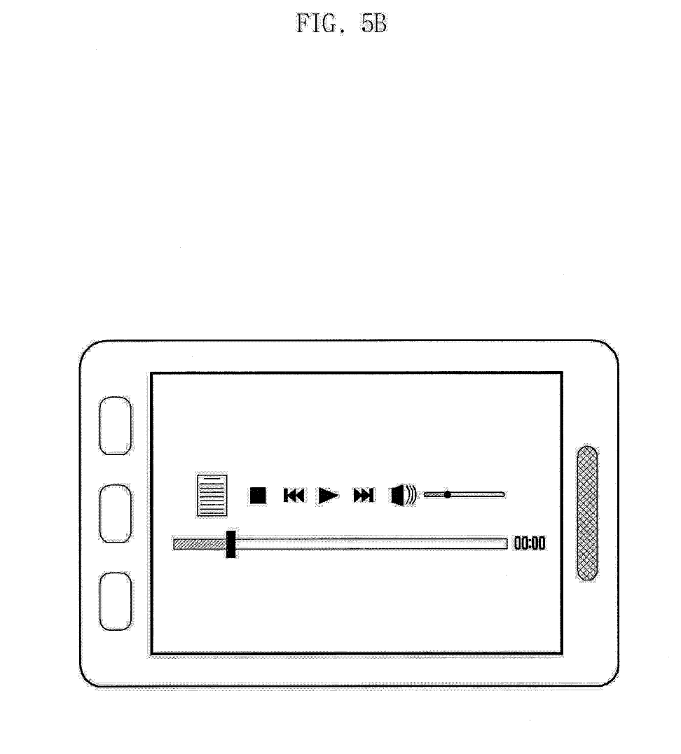

The display unit 131 displays information inputted by user or displays information to be provided to user as well as various menus of the portable terminal 100. For example, the display unit 131 may provide various screens according the use of or a function provided by the portable terminal 100, such as a home screen, a message writing screen, a web page screen, a calling screen, or other similar screens or functions. The home screen may consist of a multiple of pages. In particular, the display unit 131 may display a first screen in an external output mode, or may display a second screen in an entirety of the display unit 131 in a case where an output of the second screen, which divides the first screen, is used. For example, in a case where an output of a virtual keypad is requested for inputting a search word while displaying the web page screen, the display unit 131 may display the virtual keypad in the entirety of the display unit 131. At the same time, the web page screen is displayed in an entirety of a display unit (not shown) of the external device 200 connected with the portable terminal 100. The details thereof will be explained later with reference to FIGS. 4 and 5B. Such a display unit 131 may be formed as a Liquid Crystal Display (LCD), an Organic Light Emitting Diode (OLED) display, an Active Matrix OLED (AMOLED) display, or any other suitable display.

The touch sensing unit 132 is mounted on a front of the display unit 131, whereupon a touch event is generated according to a contact of user's finger, a stylus, or other similar input devices tools or units, and the generated touch event may be transmitted to the controller 110. The touch sensing unit 132 may recognize a touch through a change of physical quantity (e.g., capacitance and resistance, or other similar physical quantities), and transmit information corresponding to the change of the physical quantity and touched location information to the controller 110. Such a touch sensing unit 132 is well known to those skilled in the art, and thus a detailed explanation thereof is omitted herein.

The storage unit 120 may store user data, program data for a program used for a functional operation of the portable terminal 100, or other similar data or information. For example, the storage unit 120 may store a program for controlling a general operation of the portable terminal 100, an Operating System (OS) for booting the portable terminal, and an application which is used for other optional functions of the portable terminal 100, such as a camera function, a sound replay function, an image or video replay function, a short range wireless communication function, and other similar functions that may be provided by the portable terminal 100. The storage unit 120 may store a key map or a menu map for an input function of the touch sensing unit 132 for operating the touch screen 130. The key map and the menu map may be respectively configured in various forms according to a control of a user or a designer of the portable terminal 100. For example, the key map may be a keyboard map, a 3×4 key map, and a QWERTY key map, or other similar input unit maps, and may be a control key map for controlling operation of an application program currently being executed by the portable terminal 100. Furthermore, the storage unit 120 may store user data generated according to a use of the portable terminal 100, for example, a test message, a game file, a music file, a movie file, a contact number, or other similar information. In particular, the storage unit 120 may store a key map displayed in the entirety of a screen of the touch screen 130 when an input function is executed in the external output mode of the portable terminal 100. Furthermore, in a case where an input function is requested while displaying the screen, the storage unit 120 separately store a simple display area information and an input area information, and store a screen control program that transmits the separately stored information corresponding to the simple display and input areas to different devices. For example, in a case where a search word input is requested in the web page screen, the screen control program separates a web page screen which is a display area, and a virtual keypad screen which is an input area, transmits the web page screen to the external device 200, and transmits the virtual keypad screen to the touch screen 130.

The controller 110 may control a general operation of a portable terminal 100 and a signal flow between internal blocks or units of the portable terminal 100. In particular, in a case where the external output mode is activated, the controller 110 may transmit a same screen as the first screen to be displayed on the touch screen 130 and as a second screen to be displayed on the external device 200. Thereafter, the controller 110 may control determining of whether an image is to be overlaid in the first screen or whether an output of the second screen, which is separated and displayed, is requested.

In the case where the output of the separated second screen is requested, the first screen is displayed in the entirety of the display unit (not shown) of the external device 200 and the second screen is displayed in the entirety of the display unit 131 of the touch screen 130. For example, in such a case, the first screen may be a simple message writing screen, and the second screen may be a virtual keypad screen for an input of letters or characters. Alternatively, the first screen may be a web page screen, and the second screen may be a virtual keypad screen for inputting a search word or web page address, an IDentifier (ID) and a password, or other similar information. Furthermore, the first screen may be a video replay screen, and the second screen may be a control menu screen for controlling replay of a video. The details thereof will be described later.

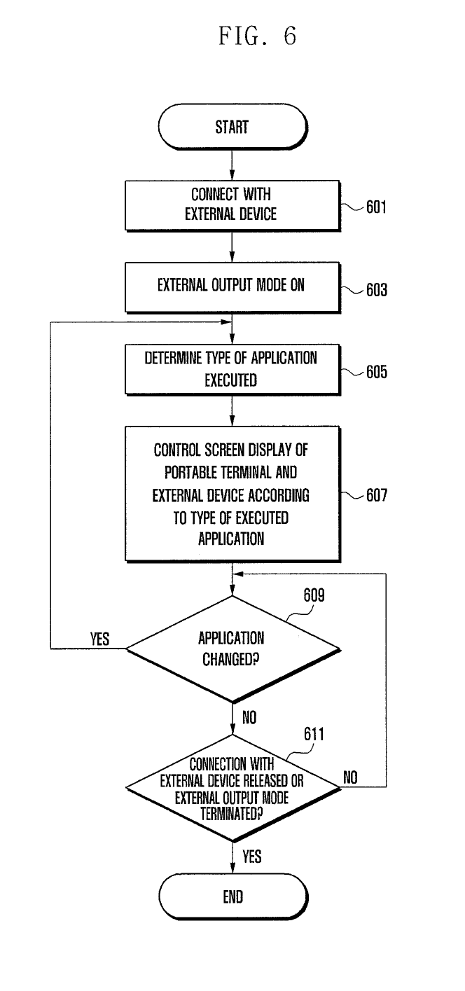

Additionally, when the external output mode is activated, the controller 110 may determine a type of an application currently being executed by the portable terminal 100, and may control a screen which is displayed in the touch screen 130 and the external device 200 according to the determined type of the application. The details thereof will be described later with reference to FIG. 6.

Though not illustrated in FIG. 2, the portable terminal 100 may selectively further include components for providing additional functions such as a camera module for taking an image or video, a broadcast receiving module for receiving a broadcast, a digital sound source replay module like an MP3 module, and a proximity sensing module for proximity sensing, or other similar modules corresponding to other similar functions. Such components may be variously modified according to a convergence trend of digital devices, and the portable terminal 100, according to the present exemplary embodiment, may further include components of the same level as that of the above mentioned components.

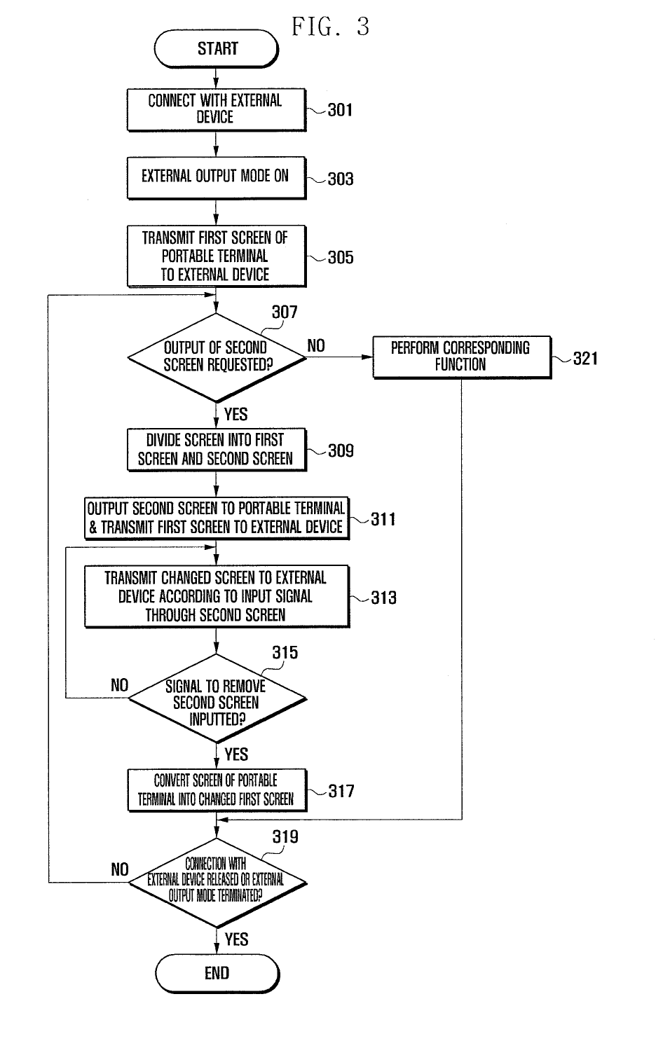

FIG. 3 is a flowchart illustrating a method of displaying a screen of a portable terminal connected with an external device according to an exemplary embodiment of the present invention.

Referring to FIGS. 1 to 3, the portable terminal 100 may be connected with the external device 200 in step 301, and the controller 110 may determine that the connection has been made and may determine activation (i.e., an ON state) of an external output mode (e.g., a TV-OUT function) which outputs the screen of the portable terminal 100 to the external device 200 in step 303. The portable terminal 100 and the external device 200 may be connected through a wired cable or a short range wireless communication unit, as discussed above with reference to FIG. 2.

After activation of the external output mode is determined, the controller 110 may transmit the first screen of the portable terminal 100 to the external device in step 305. The first screen is a screen that is currently being output by the portable terminal 100. In other words, the controller 110 may control a transmission of image data, such as video data and/or audio data, corresponding to the first screen, which is being displayed on the touch screen 130 of the portable terminal 100, to the external device 200.

Next, in step 307, the controller 110 may determine whether an output of the second screen is requested. The second screen may be overlaid in a part of the first screen or may be divided so as to be separately displayed from the first screen. For example, in a case where the first screen is a letter writing screen and a letter or character input is requested, the output request of the second screen may be a step of determining whether an input mode for inputting letters is activated. The input mode may be a Short Message Service (SMS), a long message service, an email service, a Multimedia Message Service (MMS) writing mode, a document writing mode, a memo writing mode and a search word input mode, or other similar modes.

The second screen may be a virtual keypad screen including at least one of a letter keypad for a letter input, a number keypad for a number input, and a shortcut key. The shortcut key may be a Bluetooth on/off key, a Wi-Fi on/off key, a Global Positioning System (GPS) on/off key, a Motion Picture Expert Group (MPEG)-1 or MPEG-2 audio layer-3 (MP3) key, a digital broadcast key, a letter message writing key, a camera key, and a capture key, etc. Furthermore, the second screen may further include a touch pad area for a mouse function which moves a pointer according to a touch movement, a left click area corresponding to a left button of a mouse, and a right click area corresponding to a right button of a mouse. The details thereof will be described later with reference to FIGS. 5A and 5B. Further, in a case where the first screen is a screen for replaying a video, the output request of the second screen may be generated when touching an arbitrary area of the video replay screen. Here, the second screen may be a control menu screen for controlling a replay of a video, wherein the control menu provides control buttons, such as a Fast Forward button, a Fast Backward button, a Play button, a Stop button, a Finish button, or other similar control buttons. In other words, the second screen may be differently set according to the first screen.

In the case where the output of the second screen is not requested at step 307, then the controller 110 may perform a corresponding function according to user's request in step 321, and then proceed to step 319, which will be described later. In contrast, in the case where an output of the second screen is requested at step 307, the controller 110 may divide the screen into the first screen and the second screen in step 309. Next, in step 311, the controller 110 may output the first screen so as to be displayed on the entirety of the display unit (not shown) of the external device 200, and also output the second screen on the entirety of the touch screen 130 of the portable terminal 100. That is, the controller 110 may transmit image data corresponding to the first screen to the external device 200, and may transmit image data corresponding to the second screen to the touch screen 130.

Thereafter, in step 313, the controller 110 may transmit the first screen that is changed according to an input signal inputted through the second screen which is displayed on the touch screen 130 of the portable terminal to the external device 200. Next, the controller 110 may determine whether a signal or a command to remove the second screen is inputted in step 315. If it is determined that a signal to remove the second screen is not inputted, then the controller 110 may return to step 313. In contrast, if it is determined that a signal to remove the second screen is inputted at step 315, then the controller 110 may change the screen of the touch screen 130 to the first screen in step 317. That is, the controller 110 may remove the second screen and output the same screen as the first screen, which is being displayed on the external device 200, in the touch screen 130.

Next, the controller 110 may determine whether the connection of an external device 200 is released or an external output mode is terminated in step 319. In the case where the connection of the external device 200 is not released or the external output mode is not terminated, then the controller 110 may return to step 307 and repeat the above-explained process.

According to the present exemplary embodiment, a user's convenience may be improved when using an external output mode because a displaying of the first screen and the second screen, wherein the second screen covers the first screen as the first screen and the second screen are separately outputted and displayed, and the area allocated to the first screen and the second screen are reduced when the first screen and the second screen are displayed together may be prevented.

FIG. 4 is an example of a screen for explaining a method of displaying a screen of a portable terminal connected with an external device according to an exemplary embodiment of the present invention.

Referring to FIG. 4, it is assumed that a portable terminal and an external device (monitor) are connected through a short range wireless communication method. However, the present invention is not limited thereto, and the external device may be connected through another RF connection method or through a wired connector or cable. In a state where the portable terminal 100 and the external device 200 are connected, if an external output mode is activated, then the controller 110 may transmit image data corresponding to a web page, which is being outputted in the touch screen 132, to the external device 200 as shown in a screen example 410.

The external device 200, which receives image data transmitted from the portable terminal 100, may output the received image data, which corresponds to the same web page as that of the portable terminal 100. Thereafter, if a search word input area 10 of the web page is touched, the controller 110 may divide the screen into a web page screen and a virtual keypad screen as shown in screen example 420, and transmit image data corresponding to the web page to the external device 200 so that the external device 200 outputs and displays only the web page screen. Furthermore, the controller 110 may control the touch screen 130 so as to display a virtual keypad 30 in the entirety of the touch screen 130. If a touch event occurs in an area to which an English character “A” is allocated in the virtual keypad 30, as shown in screen example 420, then the controller 110 may transmit the screen having the English character “A” displayed in the search word input area 10 to the external device 200.

Accordingly, aspects of the present invention according to the present exemplary embodiment may improve a user's convenience as the portable terminal 100 and the external device 200 are controlled to output different screens in a case where two screens are to be displayed in the state where the external output mode is activated. In particular, the present exemplary embodiment of the present invention is convenient in a case where a virtual keypad for inputting a letter a character input, such as a letter writing screen, and a screen where inputted letters are displayed should be displayed together.

FIGS. 5A and 5B are examples of a screen for displaying a virtual keypad of a portable terminal according to another exemplary embodiment of the present invention.

Referring to FIGS. 5A and 5B, as a virtual keypad 40 is outputted or displayed in the entirety of the touch screen 130 of the portable terminal 100, the present exemplary embodiment may output a relatively a large number of keys so as to be outputted or displayed in one screen. Additionally, the virtual keypad 40, according to another exemplary embodiment of the present invention, may further include a shortcut key in addition to a letter key pad and a number keypad, as shown in FIG. 5A. The shortcut key may be a Bluetooth on/off key, a Wi-Fi on/off key, a GPS on/off key, an MP3 key, a digital broadcast key, and a letter message writing key, or other similar keys for similar functions or applications.

The virtual keypad 40 may further include a touch pad area 41 for a mouse function which moves a pointer according to a touch movement, a left click area 42 corresponding to a left button of a mouse, and a right click area 43 corresponding to a right button of a mouse. Accordingly, the present exemplary embodiment of the portable terminal 100 may provide an environment which is similar to that of a desktop PC having a keyboard and a mouse. In other words, the present exemplary embodiment of FIG. 5A may provide a user environment which is familiar to the user in the external output mode.

Referring to FIG. 5B, in a case where an output of the second screen is requested while the portable terminal 100 replays a video using the external output function, then the controller 110 may control a displaying of a control menu for controlling the video so that the control menu is displayed in the touch screen 130 of the portable terminal 100. At this time, the external device 200 may output only a video replay screen without displaying the control menu. Hence, the present exemplary embodiment of FIG. 5B allows for a control menu to be displayed on the touch screen 130 of the portable terminal 100 while a video replay screen is displayed in the entirety of the screen of the external device 200. Accordingly, the control menu is not overlaid in the video replay screen of the external device 200 while the video is replayed. Thus, a user's convenience may be improved because the control menu can be display in a large size on the touch screen 130 of the portable terminal 100.

FIG. 6 is a flowchart illustrating a method for displaying a screen of a portable terminal connected with an external device according to another exemplary embodiment of the present invention.

Referring to FIG. 6, the controller 110 of the portable terminal 100 may be connected with the external device 200 in step 601, and may sense activation, i.e., an ON state of the external output mode (e.g., a TV-OUT function) in step 603. After activation of the external output mode is sensed, then the controller 110 may determine a type of the application executed by the portable terminal 100 in step 605.

Next, in step 607, the controller 110 may control a screen display of the portable terminal 100 and the external device 200 according to the type of the application executed, as determined in step 605. For example, in a case where the portable terminal 100 is executing a letter writing application, the controller 110 may control a displaying of a virtual keypad in the touch screen 130, and may output only a letter writing screen without the virtual keypad in the external device 200.

Furthermore, in a case where the video replay application is being executed, the controller 110 may control to output a control menu for controlling a video replay in the touch-screen 130, wherein the control menu may include buttons or keys, such as a Fast Forward button, a Fast Backward button, a Play button, a Stop and Finish button, or other similar buttons or keys, and may control the video replay screen to be outputted in the entirety of the screen of the external device 200. Furthermore, in a case where the screen does not need to be divided into two screens, as in a case where the home screen is displayed, the controller 110 may control the portable terminal 100 and the external device 200 so as to output or display the same screen.

Next, the controller 110 can determine whether an application is changed in step 609. If it is determined that the application is changed in step 609, then the controller 110 may return to step 605 and repeat the above described process. In contrast, in the case where it is determined that the application, which is being executed, is not changed in step 609, then the controller 110 may determine whether a connection with the external device 200 is released or an external output mode is terminated in step 611. In the case where it is determined that the connection with the external device is not released and that the external output mode is not terminated, then the controller 110 may return to step 609 and repeat the above-described process.

As discussed above, according to the present exemplary embodiments of the present invention, a method and apparatus for displaying a screen of a portable terminal connected with an external device may separately and display a first screen and a second screen in an external device and a portable terminal, respectively. The first screen and the second screen may be separately and respectively displayed in a case where the second screen would be otherwise overlaid in the first screen currently being outputted or in a case where an output of the second screen, which is divided from the first screen and separately displayed, is requested by a user of a portable terminal connected with an external device.

For example, according to the exemplary embodiments of the present invention, in a case where an input of a search word is required while web surfing, a virtual keypad for an input of a search word is may be outputted and displayed in the entirety of the touch screen of the portable terminal, and the web page screen may be displayed in the entirety of the display unit of the external device. Likewise, according to the present exemplary embodiments of the present invention, a virtual keypad is not displayed in only a part of a screen of a portable terminal, but rather, is displayed in the entirety of the screen of the portable terminal, and thus, each key may relatively be displayed as a big size key. Furthermore, a large number of keys may be displayed in one screen. For example, a keypad for inputting letters, a keypad for inputting numbers, a shortcut key, a function key, or other similar keys may be displayed in one screen. As such, the exemplary embodiments of the present invention may improve a user's convenience. Furthermore, as a first screen and second screen are separately displayed, the first screen is not covered by the second screen, and thus, a reduction of the display area of the first screen due to screen separation may be avoided.

The method for displaying a screen of a portable terminal connected with an external device according to the present exemplary embodiments of the present invention may be implemented in an executable program command form by various computer means and may be recorded in a non-transitory computer readable recording medium. In this case, the non-transitory computer readable recording medium may include a program command, a data file, and a data structure individually or a combination thereof. In the meantime, the program command recorded in a non-transitory recording medium may be specially designed or configured for the present exemplary embodiments of the present invention or be may known to a person having ordinary skill in a computer software field to be used.

The non-transitory computer readable recording medium may be any one of a magnetic storage medium, such as a hard disk, a floppy disk, a magnetic tape, or other similar magnetic storage mediums, or may be any one of on optical storage medium, such as a Compact Disc (CD), a Digital Versatile Disc (DVD), a Magneto-Optical Media such as a floptical disk, and may be a hardware device such as a Read Only Memory (ROM), a Random Access Memory (RAM), a flash memory, or other similar physical storage mediums for storing and executing program commands. Furthermore, the program command may include a machine language code created by a complier and a high-level language code executable by a computer using an interpreter. The foregoing hardware device may be configured to be operated as at least one software module to perform an operation of the present exemplary embodiments of the present invention.

While the invention has been shown and described with reference to certain exemplary embodiments thereof, it will be understood by those skilled in the art that various changes in form and details may be made therein without departing from the spirit and scope of the invention as defined by the appended claims and the equivalents.

What is claimed is:

1. A method for displaying a screen of a portable terminal connected with an external device and including a touch screen, the method comprising:
activating an external output mode for outputting the screen of the portable terminal to the external device;
transmitting the screen as a first screen, which is being outputted in the touch screen, by the portable terminal, in order to display the first screen on a display unit of the external device;
determining whether an output of a second screen, which is overlaid on the first screen or is displayed as a separate screen, is requested; and
displaying the first screen in an entirety of the display unit of the external device when it is determined that the output of the second screen is requested, and displaying the second screen in the entirety of the touch screen of the portable terminal.

2. The method of claim 1, wherein the second screen is differently set according to a type of the first screen.

3. The method of claim 1, wherein the determining of whether the output of the second screen is requested comprises determining whether an input function of the portable terminal is activated.

4. The method of claim 3, wherein the second screen is a virtual keypad screen including at least one of a letter keypad for inputting letters, a number keypad for inputting numbers, and a shortcut key.

5. The method of claim 4, wherein the displaying of the second screen comprises:
displaying a touch pad area for a mouse function which moves a pointer according to touch movement;
displaying a left click area corresponding to a left button of a mouse; and
displaying a right click area corresponding to a right button of a mouse.

6. The method of claim 1, further comprising
stopping the displaying of the second screen when a signal to remove the second screen is input; and
outputting the first screen which is being displayed in the external device in the touch screen of the portable terminal.

7. The method of claim 1, wherein the portable terminal and the external device are connected using a wired cable or a wireless communication unit.

8. A method for displaying a screen of a portable terminal connected with an external device and including a touch screen, the method comprising:
activating an external output mode for outputting the screen of the portable terminal to the external device;
determining a type of an application being executed by the portable terminal when the external output mode is being activated; and
outputting one of a same screen or different screens in the touch screen of the portable terminal and the display unit of the external device according to the type of the application being executed.

9. The method of claim 8, further comprising:
determining whether the application being executed is changed; and
determining the type of the application if it is determined that the application being executed is changed.

10. The method of claim 8, wherein the outputting of the different screens comprises outputting a control menu for controlling a replay of a video in the touch screen of the portable terminal, and outputting a video replay screen in the display unit of the external device when the type of the application is a video replay application.

11. An apparatus for displaying a screen of a portable terminal connected with an external device, the apparatus comprising:
a touch screen for displaying a screen and for sensing a touch; and
a controller for transmitting image data corresponding to a first screen being displayed on the touch screen to the external device upon activating an external output mode, for transmitting image data corresponding to the first screen to the external device when an output of a second screen, that is overlaid on the first screen or is displayed as a separate screen, is requested, and for transmitting image data corresponding to the second screen to the touch screen so as to be displayed on an entirety of the touch screen.

12. The apparatus of claim 11, further comprising at least one of:
an interface unit for a wired connection with the external device; and
a wireless communication unit for a wireless connection with the external device.

13. The apparatus of claim 11, wherein the controller determines that an output of the second screen has been requested when an input function is activated.

14. The apparatus of claim 11, wherein the second screen is a virtual keypad screen including a letter keypad for inputting letters, a number keypad for inputting numbers, and a shortcut key.

15. The apparatus of claim 14, wherein the second screen further includes:
a touch pad area for a mouse function which moves a pointer according to touch movement;
a left click area corresponding to a left button of a mouse; and
a right click area corresponding to a right button of a mouse.

16. The apparatus of claim 11, wherein the controller is for stopping the displaying of the second screen when a command to remove the second screen is received, and for outputting a same screen as the first screen being displayed in the external device to the touch screen.

17. The apparatus of claim 11, wherein the controller determines a type of an application being executed by the portable terminal when the external output mode is activated, and outputting a same screen or different screens in the touch screen and the external device.

18. The apparatus of claim 17, wherein the controller changes a screen output to the touch screen according to a change of the application being executed.
